(19) United States
(12) Patent Application Publication
(10) Pub. No.: US 2001/0007625 A1
(43) Pub. Date: Jul. 12, 2001

(54) Yoke unit

(76) Inventors: Han Kwan Moon, Pusan (KR); Jung Kun Kim, Pusan (KR); Ik Min Park, Pusan (KR); Choon Tae Lee, Pusan (KR); Joon Ho Ahn, Daegu (KR); Byung Min Kim, Pusan (KR); Dong Jin Kim, Pusan (KR); Gwan Soo Lee, Daegu (KR)

Correspondence Address: NIXON PEABODY, LLP, 8180 GREENSBORO DRIVE, SUITE 800, MCLEAN, VA, 22102, US

(21) Appl. No.: 09/752,445

(22) Filed: Jan. 3, 2001

(30) Foreign Application Priority Data
Jun. 15, 2000 (KR) 2000-16995
Jan. 7, 2000 (KR) 2000-00699

(51) Int. Cl. F16D 1/12; F16J 1/16; F16C 11/06

(52) U.S. Cl. 403/158

(57) ABSTRACT

A yoke unit connects two shaft arranged at a predetermined angle. The yoke unit has a pair of yoke portions receiving an input shaft, a clamp for clamping the input shaft, a bush disposed around the clamp, and an insert inserted into a space between the yoke portions and coupled to the bush. When the shaft is received in the yoke portions, the bush is inserted into through holes of the yoke portions such that the bush is positioned on a recess of the input shaft. The clamp passes through the bush and is screwed to any one of through holes of the yoke portions. The bush prevents the input shaft from moving an axial direction. The insert prevents the yoke portions from deforming when the clamp is fastened and when an external impact is applied to the yoke portions. A friction between the yoke unit and the input shaft can be reduced by the bush and the abrasion of the bolt and the shaft can be reduced. Noise caused by the friction between the yoke unit and the input shaft can be reduced and a local galvanic corrosion of the yoke unit caused by a galvanic cell effect can be prevented.

### BACKGROUND OF THE INVENTION

1. Field of the Invention

The present invention relates to a yoke unit, and more particularly to a yoke unit which is used for transmitting a rotational force of a steering wheel to a wheel in a vehicle.

2. Description of the Prior Arts

Generally, such a yoke unit is used to connect two shafts. The yoke unit is classified into two types, one of which connects shafts arranged in a row to each other and the other of which connects shafts arranged at a predetermined angle to each other. The former is widely used as a flange coupling and the latter is widely used as a universal joint. The universal joint comprises two yoke units in a bifurcated shape for coupling an input shaft to an output shaft, and a coupling member or a spider for displaceably coupling the two yoke units at a predetermined angle.

FIG. 1 shows a perspective view of a conventional yoke unit 10. As shown in FIG. 1, the yoke unit 10 is separated from an input shaft 20 which transmits a rotational force of a steering wheel. The yoke unit 10 has a pair of yoke portions 12 and 14, a pair of wing portions 16 and 18 which extend in parallel to each other, and a clamp which extends by passing through a pair of through holes 12a and 14a of the yoke portions 12 and 14 so as to clamp the yoke portions 12 and 14 to shaft 20 when the shaft 20 is inserted into the yoke portions 12 and 14. The clamp includes a bolt 22 and a female thread part which is tapped on any one of the yoke portions 12 and 14 to be screwed with the bolt 22.

More particularly, any one of the through holes 12a and 14a functions as a passing through hole to be inserted into by a free-thread part of the body of the bolt 22, and the other functions as a clamping hole to be screwed by a male thread part of the body of the bolt 22. The input shaft 20 is formed at an upper surface thereof with a recess 20a having a predetermined depth.

When the yoke portions 12 and 14 are connected to the input shaft 20, the input shaft 20 is firstly inserted into the yoke portions 12 and 14. In this state, the through holes 12a and 14a of the yoke portions 12 and 14 are arranged in parallel to the recess 20a of the input shaft 20, then the bolt 18 is inserted into the through hole 14a of the yoke portion 14, and runs across the recess 20a of the input shaft 20, and is screwed with the through hole 12a of the yoke portions 12.

The female thread part formed at any one of the yoke portions 12 and 14 is screwed to the male thread part of bolt 18 so that the yoke portions 12 and 14 are fixed to the shaft 20. In addition, the output shaft (not shown) is connected to the other yoke portions via a spider (not shown) which is coupled to through holes 16a and 18a of wing portions 16 and 18.

The conventional yoke unit 10 having a structure as mentioned above can transmit a rotational force of the input shaft 20, when the input shaft 20 is arranged at a predetermined angle with respect to the output shaft (not shown).

However, the yoke unit 10 generates a noise and an abrasion caused by a friction between the input shaft 20 and bolt 18 when the input shaft 20 rotates.

In addition, when the bolt 18 is fastened, a space or a width between the yoke portions 12 and 14 is decreased. If the space is subjected to a change, the wing portions 16 and 18 are also experienced with a similar change so that the yoke unit 10 cannot be smoothly operated.

### SUMMARY OF THE INVENTION

The present invention is invented to overcome the above described problems of the prior art, and accordingly it is an object of the present invention to provide a yoke unit which prevents a shaft from moving in an axial direction, improves the working efficiency on assembling thee yoke unit and the shaft, and reduces a noise caused by rotation of the shaft.

It is another object of the present invention to provide a yoke unit which prevents the yoke portions from deforming, thereby ensuring the stable operation of the yoke unit.

To achieve the above-mentioned objects, the present invention provides a yoke unit comprising:

a pair of yoke portions having through holes at each upper portion thereof, a receiving hole at a bottom portion thereof for receiving an input shaft, and a space defined between the yoke portions to communicate with the receiving hole;

a pair of wing portions integrally formed with the yoke portions and extending in parallel to each other; having through holes at each end portion thereof distal to the yoke portions;

a bush inserted into the through holes of the yoke portions so as to be placed at a recess of the shaft for preventing the input shaft from moving in an axial direction within the receiving hole of the yoke portions, the bush reducing a noise caused by a friction between the input shaft and the yoke unit; and

a clamp screwed to the yoke portions for fixing the yoke portions to the input shaft.

The bush reducing a noise caused by a friction between the input shaft and the yoke unit.

The bush is made of abrasion- and/or thermal-resistant synthetic resin having a high elasticity.

The yoke unit further comprises an insert which is inserted into the space of the yoke portions for preventing the yoke portions from deforming.

The insert is made of synthetic resin and is press-fitted into the space of the yoke portions. The insert has a coupling groove at a lower portion thereof which is coupled to the bush.

A step portion is formed at any one of the through holes of the yoke portions. The bush is inserted into the through holes of the yoke portions in such a manner that the bush extends from the other through hole of the yoke portions to the step portion.

The yoke unit may be movably fixed to the input shaft transmitting a rotational force of a steering wheel. When the shaft rotates, a noise caused by a friction between the yoke unit and the input shaft can be reduced by the bush.

In addition, since the insert prevents the yoke portions from deforming, the yoke unit can stably operate.

### BRIEF DESCRIPTION OF THE DRAWINGS

The above object and other advantages of the present invention will become more apparent by describing in detail a preferred embodiment thereof with reference to the attached drawings in which:

FIG. 1 is an exploded perspective view of a conventional yoke unit;

FIG. 2 is an exploded perspective view of a yoke unit according to a first embodiment of the present invention;

FIG. 3 is a longitudinally sectional view of a yoke unit according to a first embodiment of the present invention;

FIG. 4 is a transversely sectional view of a yoke unit according to a first embodiment of the present invention;

FIG. 5 is an exploded perspective view of a yoke unit according to a second embodiment of the present invention; and

FIG. 6 is an assembled view of a cylindrical bush and an inserter shown in FIG. 5.

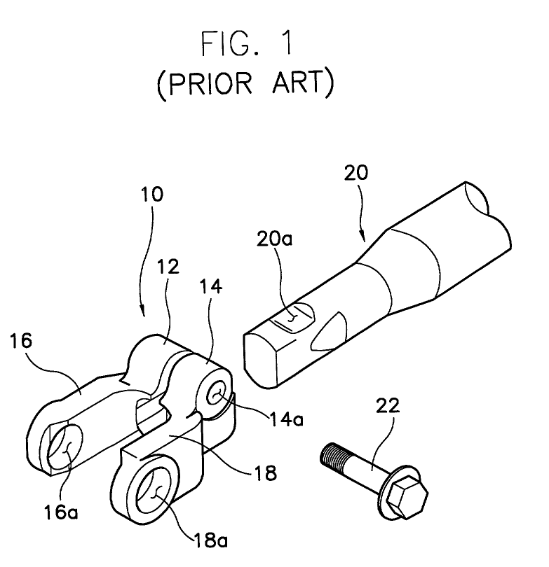

### DESCRIPTION OF THE PREFERRED EMBODIMENTS

Hereinafter, a preferred embodiment of the present invention will be described in detail with reference to the attached drawings.

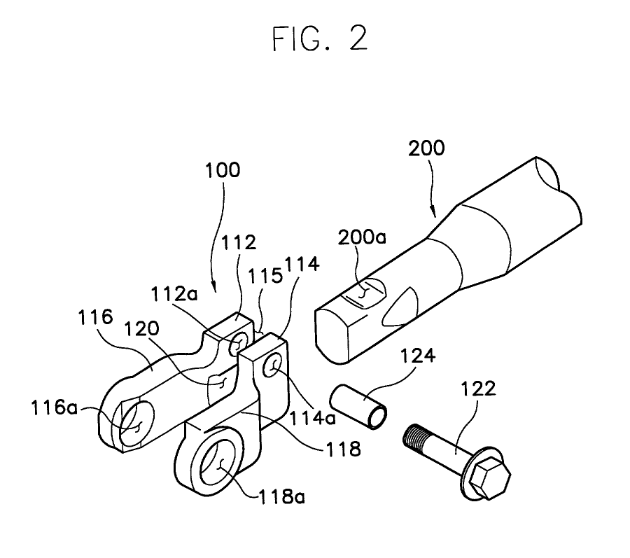

FIG. 2 shows an yoke unit 100 according to a first embodiment of the present invention, As shown in FIG. 2, the yoke unit 100 comprises a pair of yoke portions 112 and 114. Each of yoke portions 112 and 114 has a through hole at an upper portion thereof, A receiving hole 120 is formed at a bottom portion of yoke portions 112 and 114 for receiving an end portion of a shaft 200. A pair of wing portions 116 and 118 are integrally formed with the yoke portions 112 and 114. The wing portions 116 and 118 extend in parallel to each other and have through holes 116a and 1 18a formed at end portion opposite to the yoke portions 112 and 114. The through holes 116a and 118a are inserted into by a spider (not shown) in a cross shape. The spider is connected to a yoke unit corresponding to the yoke unit 100. A clamp 122 is screwed to the yoke portions 112 and 114, one of which is tapped into a female thread on its inner circumferential surface in order to couple the yoke portions 112 and 114 with the shaft 200.

The yoke portions 112 and 114 are connected to each other at the bottom portion thereof to define the receiving hole 120. The receiving hole 120 is communicated with a space or a width defined between the yoke portions 112 and 114.

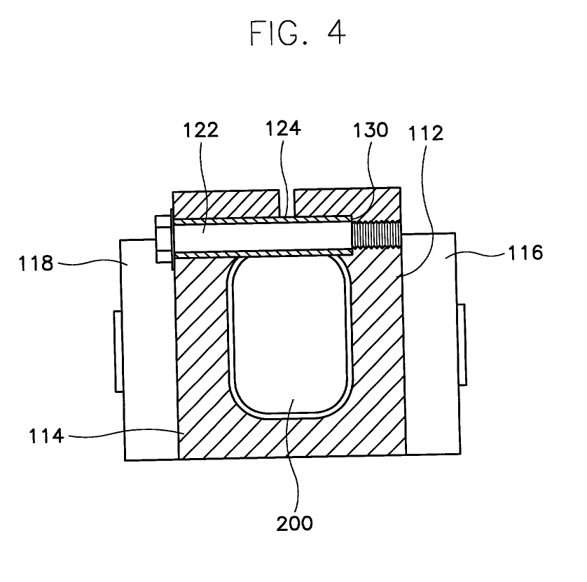

As shown in FIG. 4, a step portion 130 is formed in any one of through holes 112a and 114a of yoke portions 112 and 114. By the step portion 130 one 112a of through holes is divided from two different diameters of portions. Of these portions, a small diameter of portion is tapped into a female thread, and a large diameter of portion is not tapped. Besides the small diameter of portion, the through holes 11 2a and 114a have diameters substantially identical to a diameter of the clamp 122.

On the one hand, each of wing portions 116 and 118 extends in parallel to the yoke portions 112 and 114, respectively and has a through hole at an end portion thereof which has a diameter identical to or smaller than a diameter of the spider (not shown). Accordingly, when the yoke unit 100 is connected to the other yoke unit, the spider is press-fitted into the through holes 116a and 118a of wing portions 116 and 118 to be securely fixed via a bearing (not shown).

On the other hand, the through holes 116a and 118a may be tapered from any one of the wing portions 116 and 118 to the other of the wing portions 116 and 118. In this case, the spider may be tapered at the same angle.

When the tapered spider is connected to the through holes 116a and 118a the wing portions 116 and 118, the spider is press-fitted as the same manner as the above-mentioned constant diameter of spider.

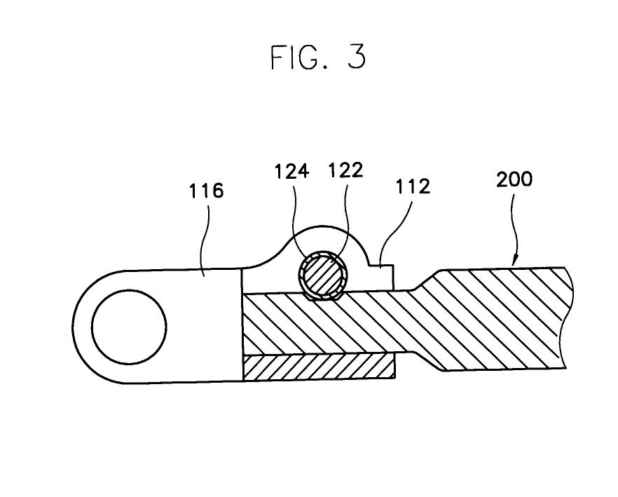

As shown in FIGS. 2 to 4, the yoke unit 100 comprises a cylindrical bush 124 for preventing the shaft 200 from moving in an axial direction. The bush 124 is inserted into through holes 112a and 114a of the yoke portions 112 and 114 in such a manner that the bush 124 is positioned at a recess of the first shaft 200.

The bush 124 is made of abrasion- and thermal-resistant synthetic resin having a high elasticity, for example, nylon 6, nylon 66, polypropylene or acetal resin. The bush 124 has a length longer than a width of one of yoke portions 112 and 114 and shorter than a width of both of yoke portions 112 and 124. Preferably, the bush 124 has a length in a range of ⅔to ¾of the width of both of yoke portions 112 and 114.

Alternatively, the bush 124 may be provided with a flange which is formed along a periphery portion of cylindrical bush 124. In addition, the bush 124 may take a tapered shape whose diameter is gradually decreased from one end to the other end. The bush 124 is also possible to be divided into two or more parts.

The cylindrical bush 124 is inserted into through holes 112a and 114a of the yoke portions 112 and 114 in such a manner that it extends from the through hole 114a of the yoke portion 114 and to the step portion 130 of the yoke portion 112.

The clamp 122 passes through the bush 124 received in the through holes 112a and 114a of the yoke portions 112 and 114 and is screwed to the through hole 112a of the yoke portion 112. At this time, a space or a width between yoke portions 112 and 114 can be adjusted by screwing the clamp 122 into the through hole 112a of the yoke portion 112.

When the clamp 122 is screwed into the through hole 112a of the yoke portion 112, the yoke portions 112 and 114 move towards each other with the shaft 200 get into contact so that the yoke portions 112 and 114 are securely fixed to the shaft 200.

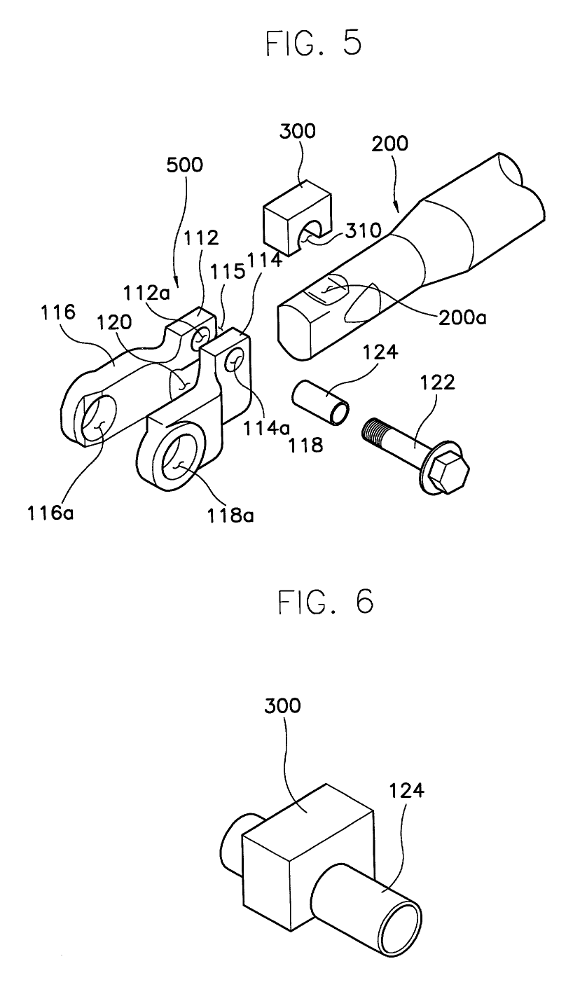

Now, FIG. 5 shows a yoke unit 500 according to the second embodiment of the present invention. In this embodiment, the yoke unit 500 further comprises an insert 300.

According to the second embodiment of the present invention, the insert 300 is press-fitted into a space or a width 115 at the upper portion of yoke portions 112 and 114 so that the space 115 between the yoke portions 112 and 114 can be constantly maintained.

As a result, the yoke portions 112 and 114 can be prevented from deformation when clamp 122 is screwed into the through hole 112a of the yoke portion 112 or when the yoke portions 112 and 114 are experienced with an external impact, thereby ensuring the stable operation of yoke unit 500.

As shown in FIG. 6, the insert 300 is formed at a lower portion thereof with a coupling groove 310. This coupling groove 310 is securely coupled to the cylindrical bush 124.

Preferably, the insert 300 is made of synthetic resin in order to release the impact applied thereon by the yoke portions 112 and 114.

Hereinafter, a process for assembling the yoke unit according to the present invention will be explained.

Firstly, an input shaft 200 is inserted into a receiving hole 120 of yoke portions 112 and 114. At this time, the input shaft 200 is positioned in the yoke portion 112 and 114 in such a manner that a recess 200a of the input shaft 200 formed on the upper surface thereof is in line with through holes 112a and 114a of the yoke portions 112 and 114.

Then, a bush 124 is inserted into through holes 112a and 114a of the yoke portions 112 and 114 until a leading end of the bush 124 reaches a step portion 130 of the yoke portion 112. As the bush 124 is inserted into through holes 1 12a and 114a of the yoke portions 112 and 114, the user has to adjust the position of the input shaft 200 with respect to the yoke portions 112 and 114 so that the bush 124 extends across the recess 200a of the input shaft 200.

After that, an insert 300 is press-fitted into a space 115 formed on the upper portion of the yoke portions 112 and 114. At this time, a coupling groove 310 of the insert 300 is also fitted around the bush 124.

Then, a clamp 122 is inserted into the bush 124 so as to be screwed into the through hole 112a of the yoke portion 112. By screwing the clamp 122 into the through hole 112a of the yoke portion 112, the yoke portions 112 and 114 move towards each other so that they are secured to the input shaft 200. At this time, the screwing work is continued until the movement of the yoke portions 112 and 114 is no longer stopped by insert 300.

Accordingly, the rotational force of the input shaft 200 can be transmitted in turn through the yoke unit 100, the spider, the other yoke unit to an output shaft in case that the input shaft 200 and the output shaft are arranged at the predetermined angle.

As above mentioned, since the yoke unit 100 of the present invention has the cylindrical bush 124 between the clamp 122 and the input shaft 200, the input shaft 200 can be prevented from moving in an axial direction thereof.

In addition, the yoke unit 100 of the present invention can reduce the noise caused by the friction between the input shaft 200 and the yoke unit 100 and a local galvanic corrosion of the yoke unit caused by a galvanic cell effect can be prevented.

Moreover, a space or a width between the yoke portions 112 and 114 can be constantly maintained so that the yoke portions 112 and 114 and the wing portions 116 and 118 can be prevented from their deformation when the clamp 122 is screwed into any one of the through holes of the yoke portions and when an external impact is applied to the yoke portions.

While the present invention has been particularly shown and described with reference to the preferred embodiment thereof, it will be understood by those skilled in the art that various changes in form and details may be effected therein without departing from the spirit and scope of the invention as defined by the appended claims:

What is claimed is:

1. A yoke unit comprising:
a pair of yoke portions having a through hole at each upper portion thereof, a receiving hole at a bottom portion thereof for receiving an input shaft, and a space communicated with the receiving hole;
a pair of wing portions integrally formed with the yoke portions and extending in parallel to each other and having through holes at each end portion thereof distal to the yoke portions;
a bush inserted into the through holes of the yoke portions so as to be positioned at a recess of the input shaft for preventing the input shaft from moving in an axial direction within the yoke portions, the bush reducing caused by a friction between the first shaft and the yoke unit; and
a clamp inserted into the bush to be screwed to the yoke portions for fixing the yoke portions to the input shaft.

2. A yoke unit as claimed in claim 1, further comprising an insert which is inserted into the space of the yoke portions for preventing the yoke portions from deforming.

3. A yoke unit as claimed in claim 2, wherein the insert is made of synthetic resin, press-fitted into the space of the yoke portions and formed at a lower portion thereof with a coupling groove which is coupled to the bush.

4. A yoke unit as claimed in claim 1, wherein the bush is made of thermal- and/or abrasion-resistant synthetic resin having a high elasticity.

5. A yoke unit as claimed in claim 1, wherein a step portion is formed at any one of the through holes of the yoke portions, the bush is inserted into the through holes in such a manner that the bush extends from the other through hole of the yoke portions to the step portion.

6. A yoke unit as claimed in claim 5, wherein the clamp extends passing through the bush placed in the yoke portions and is screwed at any one of the through holes of the yoke portions.
